(19) United States
(12) Patent Application Publication
(10) Pub. No.: US 2008/0306733 A1
(43) Pub. Date: Dec. 11, 2008

(54) IMAGING APPARATUS, VOICE PROCESSING CIRCUIT, NOISE REDUCING CIRCUIT, NOISE REDUCING METHOD, AND PROGRAM

(75) Inventor: Kazuhiko OZAWA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/047,668

(22) Filed: Mar. 13, 2008

(30) Foreign Application Priority Data
May 18, 2007 (JP) 2007-132276

(51) Int. Cl. G10L 21/02

(52) U.S. Cl. 704/226; 704/E21.001

(57) ABSTRACT

A noise reducing circuit includes a denoising unit configured to eliminate a noise band from an input voice signal; a noise recognizing unit configured to recognize noise included in the voice signal; a denoising period generating unit configured to generate a signal indicating a denoising period in accordance with an occurrence period of the recognized noise; and a selecting unit configured to select an output of the denoising unit when the denoising period is indicated and select the voice signal when the denoising period is not indicated.

### CROSS REFERENCES TO RELATED APPLICATIONS

The present invention contains subject matter related to Japanese Patent Application JP 2007-132276 filed in the Japanese Patent Office on May 18, 2007, the entire contents of which are incorporated herein by reference.

### BACKGROUND OF THE INVENTION

1. Field of the Invention

The present invention relates to an imaging apparatus, particularly to a voice processing circuit and a noise reducing circuit to reduce noise in a voice signal in an imaging apparatus, a processing method in those circuits, and a program allowing a computer to execute the method.

2. Description of the Related Art

In recent years, digital home electric appliances of which main body includes a compact microphone, such as a video camera, a digital camera, a mobile phone, and an IC recorder, have been further miniaturized. Under such circumstances, a user may unconsciously touch the microphone during recording, or noise due to a click operation of various function switches may propagate through a cabinet and be input to the microphone. As a result, uncomfortable touch noise or click noise often occurs during reproducing.

On the other hand, the above-described digital home electric appliances include a storage device to store various types of content (content of information). With the recent increasing amount of content, disc devices such as a DVD (digital versatile disc) and an HDD (hard disc drive) have been adopted. These disc devices are placed near a built-in microphone, so that vibration noise or acoustic noise from the disc devices is input to the microphone disadvantageously. Particularly, in quiet surroundings, the sensitivity of the microphone is increased by an internal AGC (automatic gain control) circuit, and thus even touch noise or click noise of a low level is very offensive to the ear. Furthermore, the built-in microphone typically has a directional characteristic generated by a combination of a nondirectional microphone unit and an operation circuit in many cases. Therefore, a noise frequency band rises due to a proximity effect peculiar to the directional characteristic, and thus noise may be more distinct than a desired voice signal.

In order to reduce the noise, the following measures have been taken in a related art. That is, a microphone unit of a built-in microphone is floated on an insulator, such as a rubber damper, so as to be isolated from a cabinet, or is floated in the air by using a rubber wire or the like, so that vibration from the cabinet is absorbed and that noise does not propagate to the microphone unit. However, even in this method, it may be impossible to completely suppress the noise. When the vibration is strong or depending on a vibration frequency, it may be impossible to obtain an effect of the insulator, or the microphone unit may resonate at a natural frequency. Thus, it is difficult to design the structure, which inhibits cost down and miniaturization. Furthermore, the above-described noise includes acoustic noise propagating through the air as sound with vibration, in addition to the vibration propagating on the cabinet. Accordingly, a noise propagation path to the microphone unit is complicated, and a sufficient noise reducing effect is not obtained in a passive method according to the related art.

Under these circumstances, a technique of reducing noise by using a masking effect in the human's hearing sense has been suggested. For example, an apparatus to reduce noise by switching voice signals by externally detecting noise occurrence timing has been suggested (e.g., see Patent Document 1: Japanese Unexamined Patent Application Publication No. 2005-303681 (FIG. 1)).

### SUMMARY OF THE INVENTION

The above-described related art is used to remove the above-described shock noise, touch noise, and click noise so that the noise is not recognized by human's ears, and is effective when a noise occurrence period can be specified.

However, the related art has the following problem. That is, when a sound other than noise is mixed in an input signal or when noise timing is not obtained from a driving device, it may be impossible to specify a noise occurrence period and to remove noise.

The present invention has been made in view of these circumstances, and is directed to reducing noise by specifying a noise occurrence period by recognizing noise even when a voice signal and noise occur at the same time.

According to an embodiment of the present invention, there is provided a noise reducing circuit including denoising means for eliminating a noise band from an input voice signal; noise recognizing means for recognizing noise included in the voice signal; denoising period generating means for generating a signal indicating a denoising period in accordance with an occurrence period of the recognized noise; and selecting means for selecting an output of the denoising means when the denoising period is indicated and selecting the voice signal when the denoising period is not indicated. Accordingly, whether denoising is to be performed or not can be selected in accordance with an occurrence period of noise included in a voice signal.

The noise recognizing means may perform noise recognition by using an evaluation value, which is an output from a convolution operation of the voice signal and a wavelet signal whose waveform is similar to that of the noise and whose average value in a predetermined period is zero. Accordingly, whether denoising is to be performed or not can be selected in accordance with a result of noise recognition in a time region.

The noise recognizing means may perform noise recognition by using an evaluation value, which is correlation between a pattern signal approximate to a frequency spectrum of the noise and the voice signal on which Fourier transform has been performed. Accordingly, whether denoising is to be performed or not can be selected in accordance with a result of noise recognition in a frequency region.

The denoising means may be realized by a filter to eliminate a noise band. Also, the denoising means may adaptively change an elimination band and a passband of the filter based on a frequency of the noise recognized by the noise recognizing means.

The selecting means may be realized by a cross-fade switch. Accordingly, cross-fade occurs with a predetermined time constant at switching between whether denoising is to be performed or not.

According to another embodiment of the present invention, there is provided a noise reducing circuit including denoising means for eliminating a noise band from an input voice signal; signal interpolating means for performing interpolation on the signal from which the noise band has been eliminated; noise recognizing means for recognizing noise included in the voice signal; denoising period generating means for generating a signal indicating a denoising period in accordance with an occurrence period of the recognized noise; and selecting means for selecting an output of the signal interpolating means when the denoising period is indicated and selecting the voice signal when the denoising period is not indicated. Accordingly, whether denoising is to be performed or not can be selected in accordance with an occurrence period of noise included in a voice signal. Also, a masking effect of audibility can be enhanced by performing interpolation on the denoised voice signal.

The signal interpolating means may include interpolation source signal generating means for generating an interpolation source signal for the interpolation; signal band attenuation means for eliminating a band other than the noise band from the interpolation source signal; level envelope generating means for generating a level envelope of the voice signal; level coefficient generating means for generating a level coefficient for the interpolation based on the level envelope; level modulating means for modulating an output of the signal band attenuation means based on the level coefficient; and combining means for combining an output of the denoising means and an output of the level modulating means and outputting a resulting combination to the selecting means. The level modulating means may modulate the output of the signal band attenuation means further based on a level masked in audibility of the human. The interpolation source signal generating means may generate any of a single or a plurality of periodic signals having a predetermined waveform and a predetermined period, a white noise signal having a uniform level in a voice band, and a composite signal of the periodic signals and the white noise signal mixed with a predetermined mixing ratio.

Alternatively, the signal interpolating means may include interpolation source signal generating means for generating an interpolation source signal for the interpolation; signal band attenuation means for eliminating a band other than the noise band from the interpolation source signal; spectrum envelope generating means for generating a frequency spectrum envelope of an output of the denoising means; spectrum coefficient generating means for generating a spectrum coefficient for the interpolation based on the spectrum envelope; spectrum modulating means for modulating an output of the signal band attenuation means based on the spectrum coefficient; level envelope generating means for generating a level envelope of the voice signal; level coefficient generating means for generating a level coefficient for the interpolation based on the level envelope; level modulating means for modulating an output of the spectrum modulating means based on the level coefficient; and combining means for combining an output of the denoising means and an output of the level modulating means and outputting a resulting combination to the selecting means. The denoising means and the signal band attenuation means may be realized by filters that adaptively change an elimination band and a passband based on a frequency of the noise recognized by the noise recognizing means.

According to another embodiment of the present invention, there is provided a voice processing circuit including voice signal obtaining means for obtaining a voice signal; denoising means for eliminating a noise band from the voice signal; signal interpolating means for performing interpolation on the signal from which the noise band has been eliminated; noise recognizing means for recognizing noise included in the voice signal; denoising period generating means for generating a signal indicating a denoising period in accordance with an occurrence period of the recognized noise; and selecting means for selecting an output of the signal interpolating means when the denoising period is indicated and selecting the voice signal when the denoising period is not indicated. Accordingly, whether denoising is to be performed or not can be selected in accordance with an occurrence period of noise included in an obtained voice signal. Also, the masking effect of audibility can be enhanced by performing interpolation on the denoised voice signal.

According to another embodiment of the present invention, there is provided a voice processing circuit including first voice signal obtaining means for obtaining a first voice signal; denoising means for eliminating a noise band from the first voice signal; signal interpolating means for performing interpolation on the signal from which the noise band has been eliminated; second voice signal obtaining means for obtaining a second voice signal; noise recognizing means for recognizing noise included in the second voice signal; denoising period generating means for generating a signal indicating a denoising period in accordance with an occurrence period of the recognized noise; and selecting means for selecting an output of the signal interpolating means when the denoising period is indicated and selecting the first voice signal when the denoising period is not indicated. Accordingly, whether denoising is to be performed or not on the first voice signal can be selected in accordance with an occurrence period of noise included in the second voice signal. Also, the masking effect of audibility can be enhanced by performing interpolation on the denoised voice signal.

According to another embodiment of the present invention, there is provided an imaging apparatus including imaging means for capturing an image signal from a subject; voice signal obtaining means for obtaining a voice signal from the subject; denoising means for eliminating a noise band from the voice signal; signal interpolating means for performing interpolation on the signal from which the noise band has been eliminated; noise recognizing means for recognizing noise included in the voice signal; denoising period generating means for generating a signal indicating a denoising period in accordance with an occurrence period of the recognized noise; selecting means for selecting an output of the signal interpolating means when the denoising period is indicated and selecting the voice signal when the denoising period is not indicated; and recording means for recording the image signal and the voice signal by multiplexing the image signal and the voice signal. Accordingly, in the imaging apparatus, whether denoising is to be performed or not can be selected in accordance with an occurrence period of noise included in a voice signal. Also, the masking effect of audibility can be enhanced by performing interpolation on the denoised voice signal.

According to another embodiment of the present invention, there is provided a noise reducing method for a voice signal in an imaging apparatus including imaging means for capturing an image signal from a subject, voice signal obtaining means for obtaining a voice signal from the subject, and denoising means for eliminating a noise band from the voice signal. The noise reducing method includes the steps of recognizing noise included in the voice signal; generating a signal indicating a denoising period in accordance with an occurrence period of the recognized noise; and selecting an output of the denoising means when the denoising period is indicated and selecting the voice signal when the denoising period is not indicated. Also, there is provided a program allowing a computer to execute those steps. Accordingly, whether denoising is to be performed or not can be selected in accordance with an occurrence period of noise included in a voice signal.

According to an embodiment of the present invention, an excellent effect of reducing noise can be obtained by specifying a noise occurrence period by recognizing noise.

### BRIEF DESCRIPTION OF THE DRAWINGS

FIG. 1 illustrates an example of a configuration of an imaging apparatus according to an embodiment of the present invention;

FIG. 2 illustrates a first configuration example of a noise reducing unit according to the embodiment of the present invention;

FIGS. 3A and 3B illustrate a masking phenomenon used in the embodiment of the present invention;

FIG. 4 illustrates an example of a configuration of an interpolation source signal generating unit according to the embodiment of the present invention;

FIGS. 5A and 5B illustrate an example of frequency characteristics of a denoising filter and an inverse filter according to the embodiment of the present invention;

FIG. 6 illustrates an example of a configuration of a level envelope generating unit according to the embodiment of the present invention;

FIGS. 7A to 7C illustrate an example of a process performed by the level envelope generating unit according to the embodiment of the present invention;

FIG. 8 illustrates an example of an interpolation signal according to the embodiment of the present invention;

FIG. 9 illustrates another example of the interpolation signal according to the embodiment of the present invention;

FIGS. 10A and 10B illustrate an example of configurations of a noise recognizing unit according to the embodiment of the present invention;

FIG. 11 illustrates an example of a configuration of a cross-face switch as an example of a selecting switch according to the embodiment of the present invention;

FIGS. 12A and 12B illustrate an example of signal waveforms of the cross-fade switch according to the embodiment of the present invention;

FIG. 13 illustrates an example of an interpolation signal in a case where the cross-fade switch according to the embodiment of the present invention is used;

FIG. 14 illustrates a second configuration example of the noise reducing unit according to the embodiment of the present invention;

FIG. 15 illustrates a third configuration example of the noise reducing unit according to the embodiment of the present invention;

FIG. 16 illustrates a fourth configuration example of the noise reducing unit according to the embodiment of the present invention; and

FIG. 17 illustrates an example of a basic processing procedure of a noise reducing method for a voice signal according to the embodiment of the present invention.

### DESCRIPTION OF THE PREFERRED EMBODIMENTS

Hereinafter, an embodiment of the present invention is described in detail with reference to the drawings.

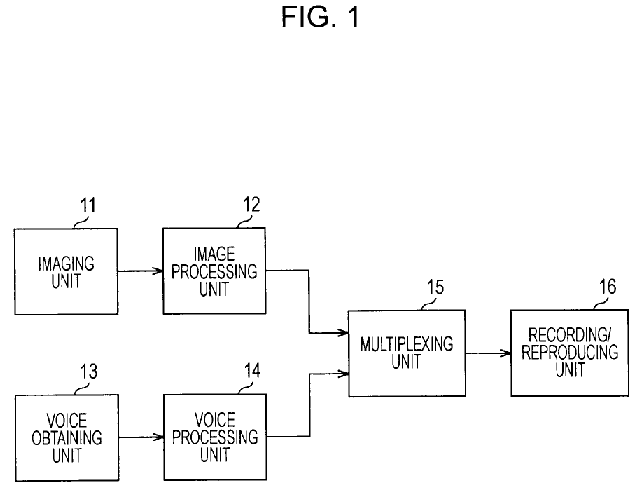

FIG. 1 illustrates an example of a configuration of an imaging apparatus according to the embodiment of the present invention. The imaging apparatus includes an imaging unit 11, an image processing unit 12, a voice obtaining unit 13, a voice processing unit 14, a multiplexing unit 15, and a recording/reproducing unit 16.

The imaging unit 11 captures an image of a subject as an image signal and is realized by, for example, a CCD (charge coupled device) sensor or a CMOS (complementary metal oxide semiconductor) sensor. The image processing unit 12 performs predetermined image processing on the image signal captured by the imaging unit 11.

The voice obtaining unit 13 obtains a voice signal from a subject, and is realized by a microphone, for example.

The voice processing unit 14 performs predetermined signal processing on the voice signal obtained by the voice obtaining unit 13.

The multiplexing unit 15 multiplexes the image signal from the image processing unit 12 and the voice signal from the voice processing unit 14 and outputs a resulting coded signal based on an MPEG (Moving Picture Experts Group) method or the like. The recording/reproducing unit 16 records the coded signal generated through multiplexing by the multiplexing unit 15 on a recording medium or decodes and reproduces the coded signal.

In the imaging apparatus illustrated in FIG. 1, the embodiment of the present invention is particularly characterized by a noise reducing unit included in the voice processing unit 14. Hereinafter, the noise reducing unit is described with reference to the drawings.

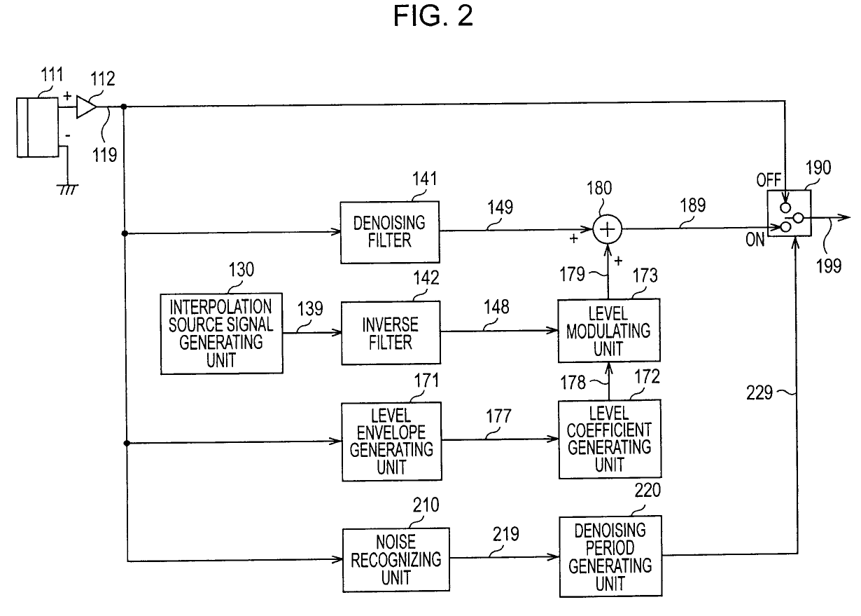

FIG. 2 illustrates a first configuration example of the noise reducing unit according to the embodiment of the present invention. The noise reducing unit receives a voice signal from a microphone 111 and performs a noise reducing process on the voice signal. The microphone 111 is a voice collecting microphone provided in the imaging apparatus or at the periphery thereof. A negative-side terminal of the microphone 111 is grounded on a ground level (GND) of the circuit, while a positive-side terminal thereof connects to an amplifier 112. The amplifier 112 amplifies a voice signal. The amplified voice signal is supplied to each unit of the noise reducing unit through a signal line 119.

The noise reducing unit includes an interpolation source signal generating unit 130, a denoising filter 141, an inverse filter 142, a level envelope generating unit 171, a level coefficient generating unit 172, a level modulating unit 173, a combining unit 180, a selecting switch 190, a noise recognizing unit 210, and a denoising period generating unit 220.

The denoising filter 141 is a filter to eliminate a noise band from a voice signal from the microphone 111. The denoising filter 141 is realized by, for example, a BEF (band elimination filter) to eliminate a single frequency band or a plurality of frequency bands. An output of the denoising filter 141 is supplied to one of input terminals of the combining unit 180 through a signal line 149.

The interpolation source signal generating unit 130 generates an interpolation source signal for interpolation. In the embodiment of the present invention, an interpolation signal is combined with a voice signal from which a noise band has been eliminated by the denoising filter 141, so that a masking effect of the human's hearing sense can be enhanced. The interpolation source signal generating unit 130 outputs an interpolation source signal, which a source of an interpolation signal. The interpolation source signal is generated by appropriately mixing a tone signal and a random signal. The configuration of the interpolation source signal generating unit 130 is described below.

The inverse filter 142 is a filter to eliminate a band other than a noise band from the interpolation source signal generated by the interpolation source signal generating unit 130. The inverse filter 142 has an inverse filter characteristic with respect to the denoising filter 141. The stopband of the denoising filter 141 is the passband of the inverse filter 142, in other words, the passband of the denoising filter 141 is the stopband of the inverse filter 142. An output of the inverse filter 142 is supplied to the level modulating unit 173 through a signal line 148.

The level envelope generating unit 171 continuously detects a level envelope of the voice signal from the microphone 111. An output of the level envelope generating unit 171 is supplied to the level coefficient generating unit 172 through a signal line 177.

The level coefficient generating unit 172 generates a level coefficient based on the level envelope supplied from the level envelope generating unit 171. An output of the level coefficient generating unit 172 is supplied to the level modulating unit 173 through a signal line 178.

The level modulating unit 173 performs level modulation on the interpolation source signal supplied from the inverse filter 142 in accordance with the level coefficient supplied from the level coefficient generating unit 172, and then outputs the signal as an interpolation signal. The output of the level modulating unit 173 is supplied to the other of the input terminals of the combining unit 180 through a signal line 179.

The combining unit 180 combines the voice signal supplied from the denoising filter 141 through the signal line 149 and the interpolation signal supplied from the level modulating unit 173 through the signal line 179. The combining unit 180 is realized by an adder, for example. An output of the combining unit 180 is supplied to an ON input terminal of the selecting switch 190 through a signal line 189.

The noise recognizing unit 210 recognizes noise included in the voice signal from the microphone 111. An output of the noise recognizing unit 210 is supplied to the denoising period generating unit 220 through a signal line 219. After the noise recognizing unit 210 has recognized noise, the denoising period generating unit 220 generates a signal indicating a denoising period in accordance with a noise occurrence period. An output of the denoising period generating unit 220 is supplied to a control terminal of the selecting switch 190 through a signal line 229.

The selecting switch 190 selects a voice signal in accordance with the signal supplied from the denoising period generating unit 220 through the signal line 229. That is, the selecting switch 190 selects the voice signal supplied from the combining unit 180 through the signal line 189 if the signal from the denoising period generating unit 220 indicates a denoising period, and selects the voice signal supplied from the microphone 111 through the signal line 119 if the signal from the denoising period generating unit 220 indicates a non denoising period. An output of the selecting switch 190 is supplied through a signal line 199 for a process in the subsequent stage.

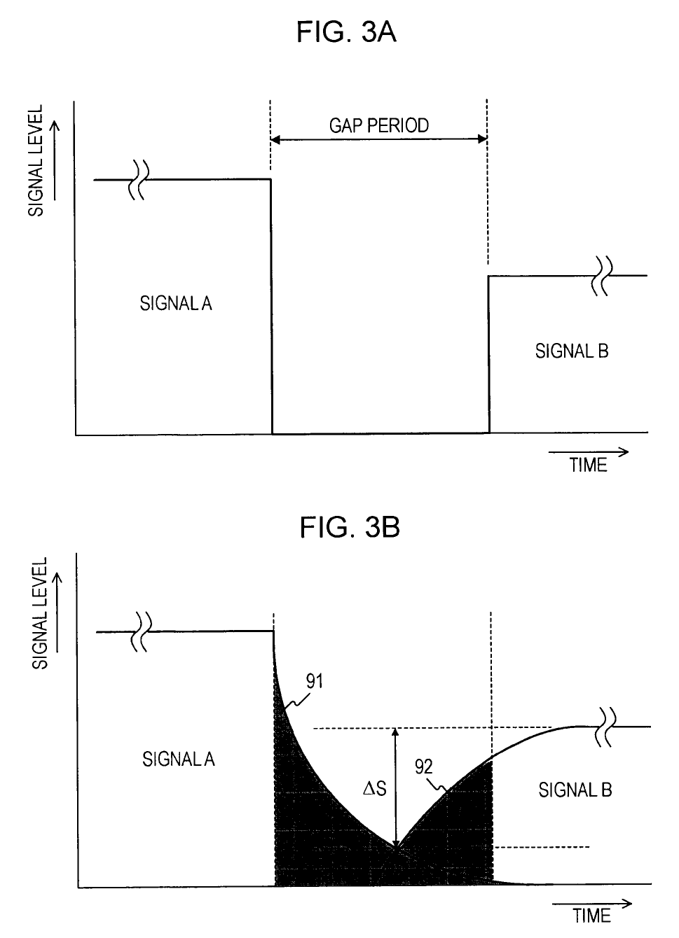

FIGS. 3A and 3B illustrate a masking phenomenon used in the embodiment of the present invention. The human's hearing sense does not recognize little sound behind relatively loud sound, for example, human's voice is difficult to hear in high-level noise. Such a phenomenon is called a making phenomenon, which depends on conditions including a frequency component, a voice pressure level, and duration. This masking phenomenon of the hearing sense is roughly classified into frequency masking and time masking, and the time masking is classified into simultaneous masking and nonsimultaneous masking (successive masking). The masking phenomenon is applied as high-efficiency coding to compress an audio signal to about one fifth to one tenth in a CD (compact disc) or the like.

In FIGS. 3A and 3B, a lapse of time is indicted in the horizontal direction, and an absolute value of a signal level at each time is indicated in the vertical direction. As illustrated in FIG. 3A, signal A is input in a predetermined level and then signal B is input in a predetermined level after a gap period with no signal. In that case, a human's audibility level is schematically illustrated in FIG. 3B. That is, in the human's audibility, the pattern of signal A remains for a while after signal A disappears, with the sensitivity decreasing, as indicated by a region 91. This phenomenon is called forward masking. During this period, the human's audibility does not recognize other sound, if any. Also, just before signal B is input, a decrease in sensitivity occurs as indicated by a region 92. This is called backward masking. During this period, the human's audibility does not recognize other sound, if any.

In normal cases, the amount of forward masking is larger than the amount of backward masking. The duration of this phenomenon depends on conditions, but is several hundred milliseconds at the maximum. Under a certain condition, several milliseconds to several tens of milliseconds are not recognized by the audibility during the gap period illustrated in FIG. 3A, and a phenomenon in which signal A and signal B are heard as continuous sound occurs. It is known that such a phenomenon has the following characteristics, as described in a research paper about gap detection by R. Plomp (1963), a research paper by Miura (JAS. Journal 94. November), and “An Introduction to the Psychology of Hearing” (written by Brian C. J. Moore, translated by Kengo Ogushi, and published by Seishinshobo, Chapter 4: The temporal resolution of the auditory system).

(First characteristic): The gap length is long when frequency bands of signals A and B have a correlation. Also, the gap length is long when the continuity of signals A and B is maintained in terms of frequency.

(Second characteristic): The gap length is longer in a band signal than in a single sine-wave signal.

(Third characteristic): When the levels of signals A and B are the same, the gap length is longer as the signal level is lower, and the gap length does not change any more after the signal level increases beyond a certain level.

(Fourth characteristic): The gap length is longer when the level of signal B is lower than the level of signal A.

(Fifth characteristic): The gap length is longer as a center frequency included in the signal is lower, and the gap length is shorter as the center frequency is higher.

In the embodiment of the present invention, the level coefficient generating unit 172 generates a level coefficient for interpolation in view of those five characteristics. For example, the level coefficient generating unit 172 allows the gap period to be long when a voice level is low (third characteristic), and allows the gap period to be longer when the voice level is temporally on the downward trend than on the upward trend (fourth characteristic).

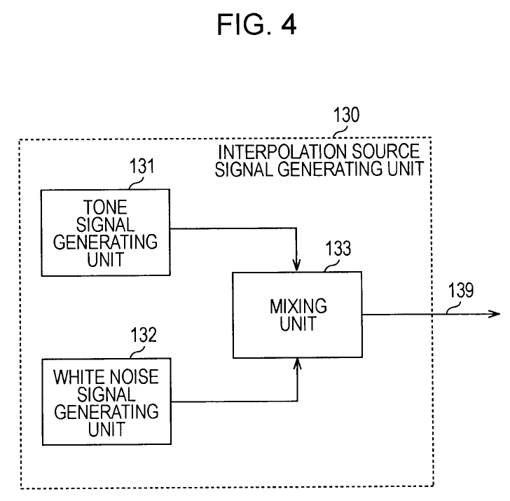

FIG. 4 illustrates an example of a configuration of the interpolation source signal generating unit 130 according to the embodiment of the present invention. The interpolation source signal generating unit 130 includes a tone signal generating unit 131, a white noise signal generating unit 132, and a mixing unit 133.

The tone signal generating unit 131 generates a tone signal composed of a single or a plurality of sine waves or pulse waves of predetermined cycles. The tone signal has a single or a plurality of peaks at a predetermined frequency based on a frequency characteristic.

The white noise signal generating unit 132 generates a white noise signal (random signal) of which level is uniform over an entire voice band. The white noise signal generating unit 132 is realized by, for example, a random number generator of M-sequence.

The mixing unit 133 mixes the tone signal generated by the tone signal generating unit 131 and the white noise signal generated by the white noise signal generating unit 132 in a predetermined mixing ratio and outputs the generated signal as an interpolation source signal. The output of the mixing unit 133 is supplied to the inverse filter 142 through a signal line 139.

The above-described predetermined mixing ratio is appropriately set in accordance with a denoising band characteristic of the denoising filter 141. Alternatively, any one of the signals may be set to zero and only the tone signal or only the white noise signal may be output as an interpolation source signal.

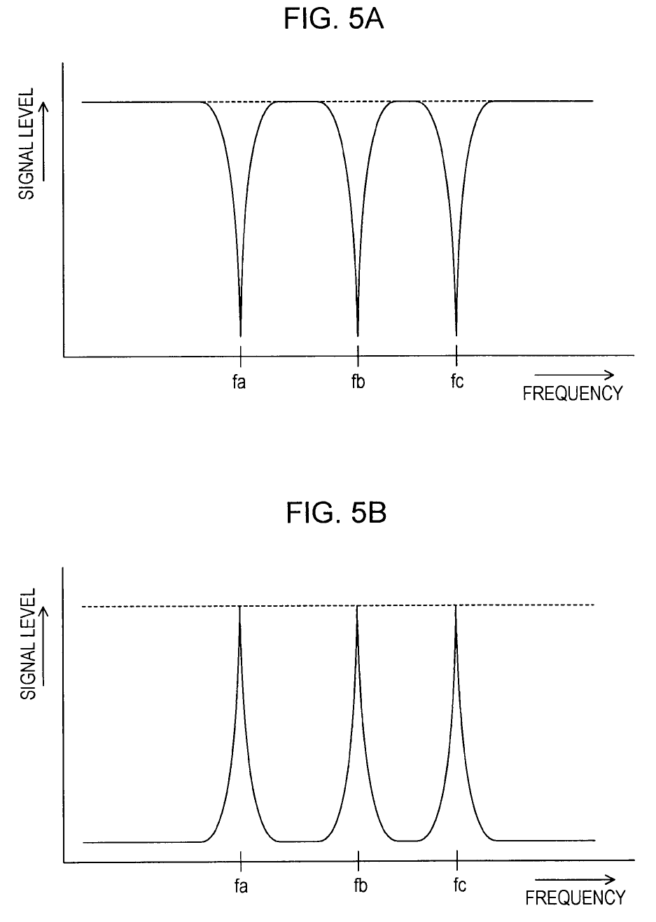

FIGS. 5A and 5B illustrate an example of frequency characteristics of the denoising filter 141 and the inverse filter 142 according to the embodiment of the present invention. In the figures, the horizontal axis indicates frequencies and the vertical axis indicates levels of a signal passing through the filter.

FIG. 5A illustrates an example of the frequency characteristic of the denoising filter 141. As illustrated, the filter has three center frequencies fa, fb, and fc of an elimination band. On the other hand, FIG. 5B illustrates an example of the frequency characteristic of the inverse filter 142. In contrast to the denoising filter 141, the inverse filter 142 has three center frequencies fa, fb, and fc of a passband.

That is, in this example, the center frequencies fa, fb, and fc constitute a noise band. The denoising filter 141 deals with the noise band as an elimination band, whereas the inverse filter 142 deals with the noise band as a passband.

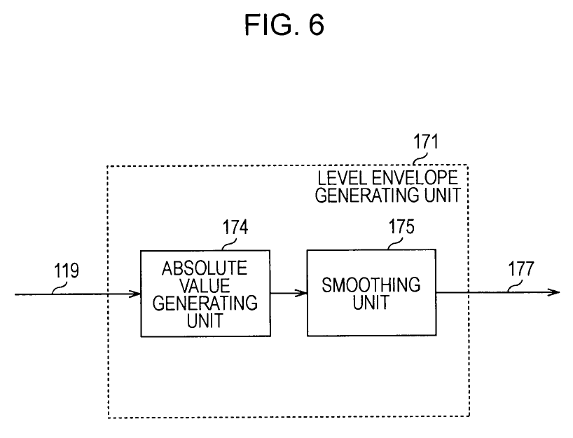

FIG. 6 illustrates an example of a configuration of the level envelope generating unit 171 according to the embodiment of the present invention. The level envelope generating unit 171 includes an absolute value generating unit 174 and a smoothing unit 175.

The absolute value generating unit 174 generates an absolute value of the voice signal supplied through the signal line 119. The smoothing unit 175 extracts a low-band component from the voice signal that has been transformed into an absolute-value signal by the absolute value generating unit 174 and smoothes the low-band component. The smoothing unit 175 is realized by, a low-pass filter (LPF), for example. The smoothing enables elimination of an effect due to an abrupt change in level, such as instantaneous noise.

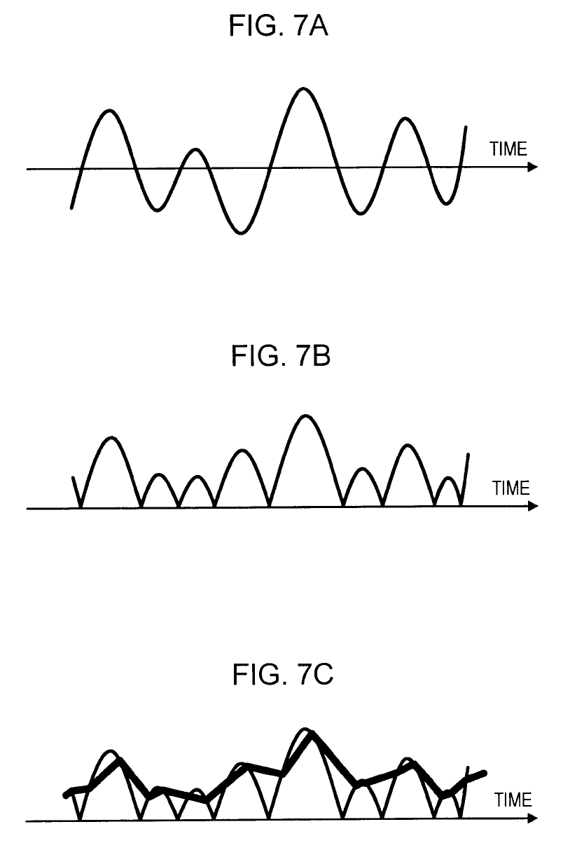

FIGS. 7A to 7C illustrate an example of a process performed by the level envelope generating unit 171 according to the embodiment of the present invention. FIG. 7A illustrates an example of a waveform of the voice signal supplied to the level envelope generating unit 171 through the signal line 119. This voice signal is transformed into an absolute-value signal by the absolute value generating unit 174, so as to have the waveform illustrated in FIG. 7B.

Then, the absolute-value signal having the waveform illustrated in FIG. 7B is smoothed by the smoothing unit 175, so that an envelope is generated as illustrated with a bold line in FIG. 7C.

Based on the level envelope generated in the above-described manner, the level coefficient generating unit 172 generates a level coefficient. By controlling the level modulating unit 173 by using this level coefficient, an interpolation signal is generated.

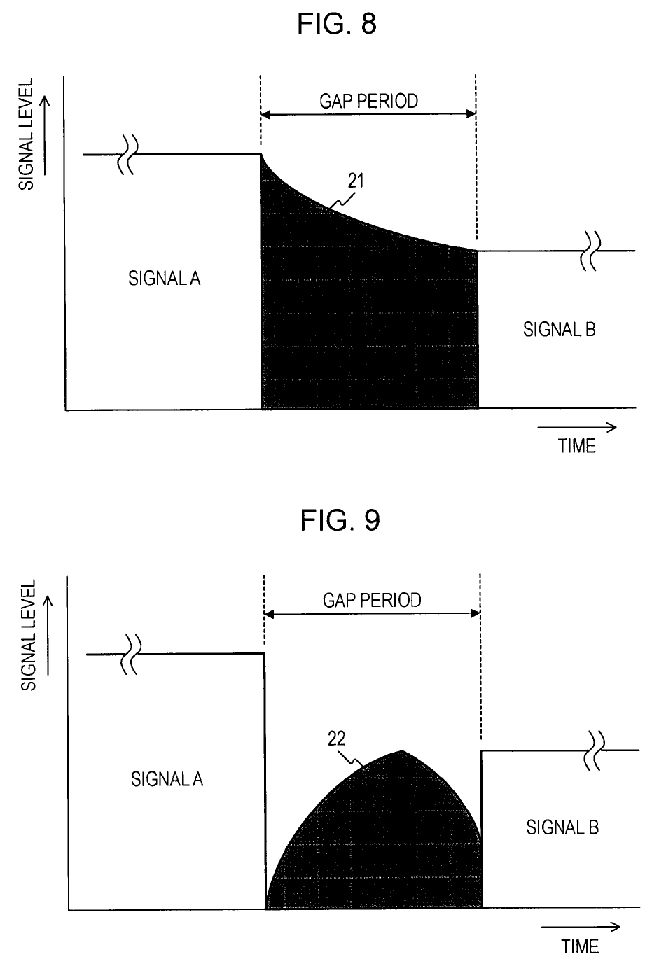

FIG. 8 illustrates an example of an interpolation signal according to the embodiment of the present invention. In this example, an interpolation signal 21 is generated to maintain the continuity between the frequencies of signals A and B, based on the level envelope generated by the level envelope generating unit 171. Accordingly, a large gap length can be obtained in accordance with the above-described first characteristic.

FIG. 9 illustrates another example of the interpolation signal according to the embodiment of the present invention. In this example, an interpolation signal 22 to compensate for a gap ΔS between the forward and backward maskings illustrated in FIG. 3B and signal B is generated. Accordingly, the gap is not sensed by audibility. That is, in the example illustrated in FIG. 9, the continuity between signals A and B is not ensured unlike in the example illustrated in FIG. 8, but level interpolation is performed so that the gap period is masked in audibility.

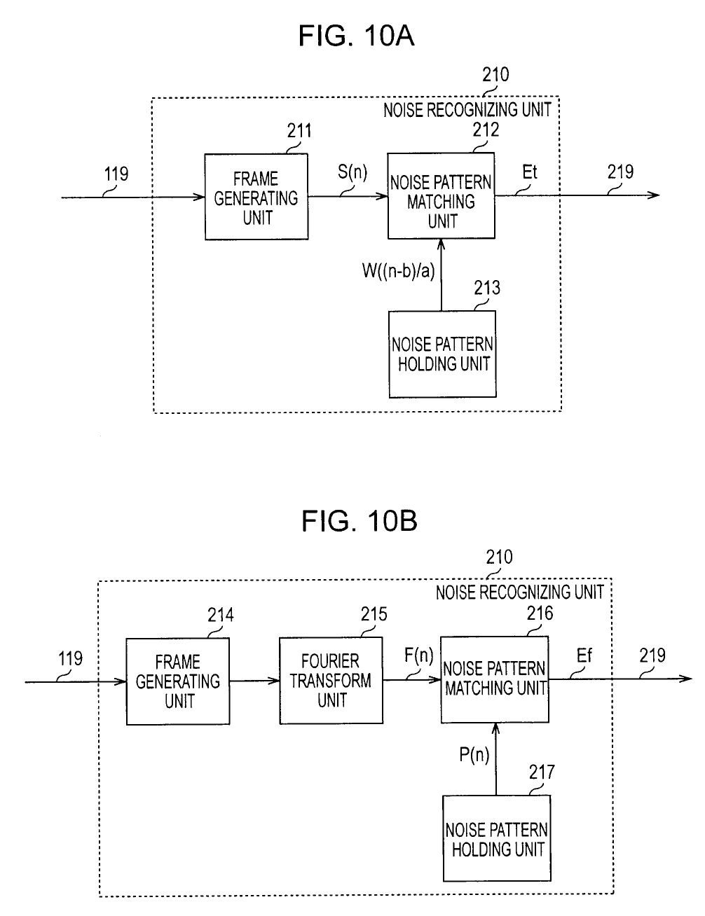

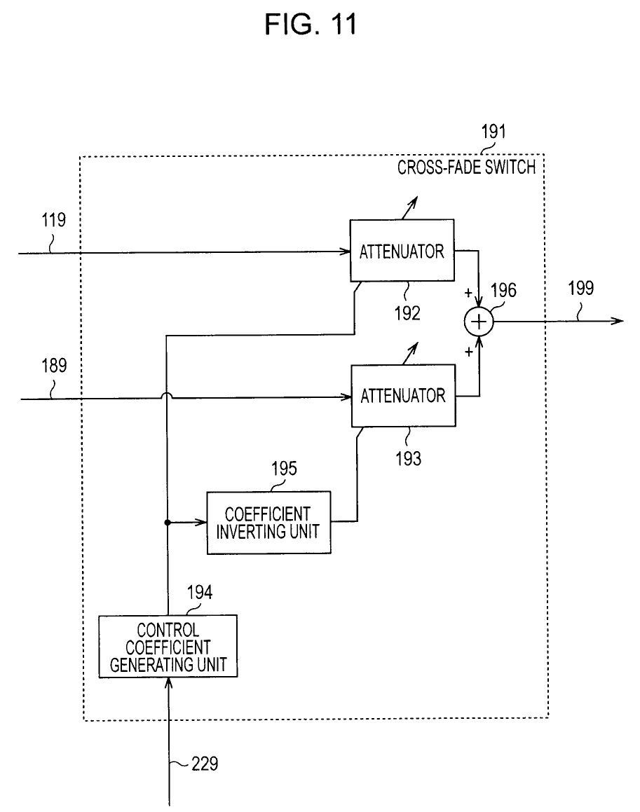

FIGS. 10A and 10B illustrate an example of configurations of the noise recognizing unit 210 according to the embodiment of the present invention. In FIG. 10A, noise is recognized in a time region. In FIG. 10B, noise is recognized in a frequency region.

In the configuration example illustrated in FIG. 10A, the noise recognizing unit 210 includes a frame generating unit 211, a noise pattern matching unit 212, and a noise pattern holding unit 213.

The frame generating unit 211 transforms voice signals supplied through the signal line 119 into frames at predetermined time intervals. Here, the frame is a data sequence including a plurality of voice signal elements (audio sample). N voice signals S(n) (N is an integer) transformed into frames are supplied to the noise pattern matching unit 212. Note that “n” is an integer ranging from 1 to N.

The noise pattern holding unit 213 is a memory to hold a noise pattern W(n). This noise pattern (also called wavelet) is read from the noise pattern holding unit 213 as a function W((n−b)/a) of “a” and “b”. Here, “a” is a scale parameter (a>0). If this value is small, that corresponds to noise recognition of a low frequency component. On the other hand, if the scale parameter is large, that corresponds to noise recognition of a high frequency component. On the other hand, “b” is a shift parameter, which indicates a shift position (time) at pattern matching with a noise pattern. Wavelet is a signal having an average value of 0 and is a function localized around time 0. In the embodiment of the present invention, a function approximate to an actual noise waveform is selected in advance and is held in the noise pattern holding unit 213.

The noise pattern matching unit 212 performs a convolution operation on the voice signals S(n) transformed into frames by the frame generating unit 211 and the noise pattern W(n) held in the noise pattern holding unit 213 while changing “a” and “b”, so as to evaluate noise existing in the voice signals. In this case, an evaluation value Et is calculated by using the following expression.

$$Et = {\sum }_{n = 1}^{N} ( S ( n ) \times W ( ( n - b ) / a ) )$$

That is, the evaluation value Et is an index indicating how much noise pattern W(n) is included in the voice signals S(n). The evaluation value Et is large when noise exists in the voice signals S(n) of respective frames, whereas the evaluation value Et is approximate to zero when the correlation with noise is low.

In the configuration example illustrated in FIG. 10B, the noise recognizing unit 210 includes a frame generating unit 214, a Fourier transform unit 215, a noise pattern matching unit 216, and a noise pattern holding unit 217.

The frame generating unit 214 transforms voice signals supplied through the signal line 119 into frames at predetermined time intervals, as the frame generating unit 211. The Fourier transform unit 215 performs Fourier transform based on FFT (fast Fourier transform) on each voice signal transformed into a frame by the frame generating unit 214, so as to transform the voice signal from a time signal into a frequency signal F(n).

The noise pattern holding unit 217 is a memory to hold a noise pattern P(n). The noise pattern P(n) held in the noise pattern holding unit 217 is generated by modeling frequency distribution when noise occurs.

The noise pattern matching unit 216 calculates the correlation between the voice signal F(n) generated by the Fourier transform unit 215 and the noise pattern P(n) held in the noise pattern holding unit 213 so as to evaluate noise existing in the voice signal. In this case, an evaluation value Ef is calculated by using the following expression.

$$Ef = \frac{{\sum }_{n = 1}^{N} \{ F ( n ) \times P ( n ) \}}{\sqrt{{\sum }_{n = 1}^{N} {\{ F ( n ) \}}^{2} \times {\sum }_{n = 1}^{N} {\{ P ( n ) \}}^{2}}}$$

Here, N is the number of FFT points in one frame. That is, when “n” is 1 to N and the similarity between the noise pattern and the voice signal is high, the evaluation value Ef is approximate to 1. If the evaluation value Ef is a predetermined threshold or higher, it can be recognized that the both patterns substantially match.

When the noise is recognized in the above-described manner, the denoising period generating unit 220 generates a denoising period, which a period defined by a start point and an end point of noise occurrence. Here, the methods for recognizing noise in the time region and the frequency region have been described, but a recognition rate can be further increased by combining those methods.

In the example illustrated in FIG. 2, description has been made assuming that the selecting switch 190 is a simple switch. Alternatively, the selecting switch 190 may be realized by a cross-fade switch described below.

FIG. 11 illustrates an example of a configuration of a cross-fade switch 191, which is an example of the selecting switch 190 according to the embodiment of the present invention. The cross-fade switch 191 includes attenuators 192 and 193, a control coefficient generating unit 194, a coefficient inverting unit 195, and a combining unit 196.

The attenuators 192 and 193 attenuate an input signal in accordance with a control coefficient. The control coefficient of the attenuator 192 is supplied from the control coefficient generating unit 194, whereas the control coefficient of the attenuator 193 is supplied from the coefficient inverting unit 195.

The control coefficient generating unit 194 generates the control coefficient of the attenuator 192 based on the denoising period supplied through the signal line 229. The coefficient inverting unit 195 inverts the output of the control coefficient generating unit 194. That is, the control coefficients of the attenuators 192 and 193 are inverted to each other.

The combining unit 196 combines the outputs of the attenuators 192 and 193 and is realized by an adder, for example.

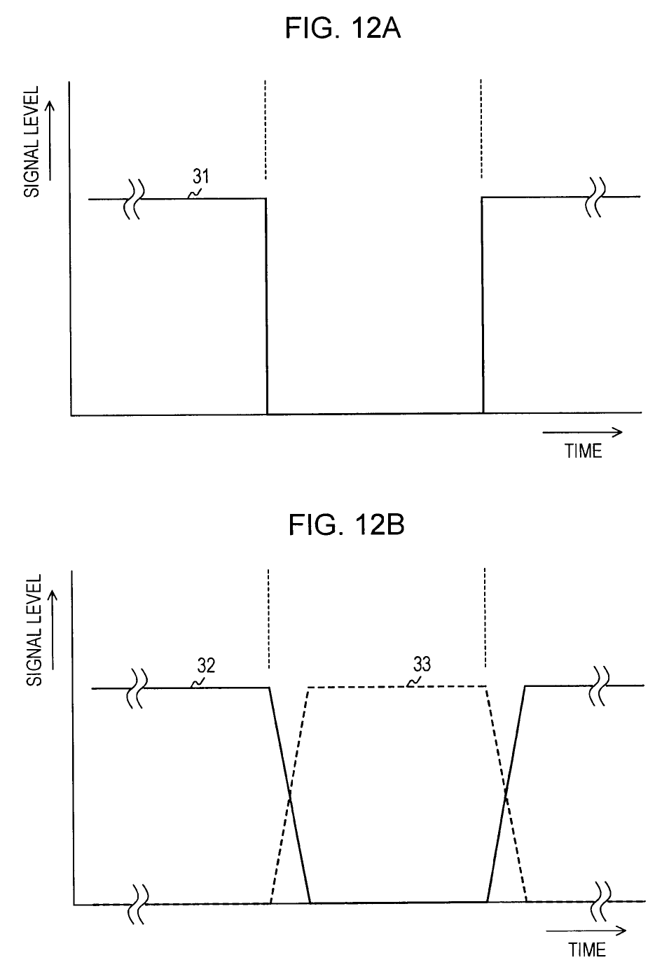

FIGS. 12A and 12B illustrate an example of waveforms of signals of the cross-fade switch 191 according to the embodiment of the present invention. When a signal 31 illustrated in FIG. 12A is input to the signal line 229, the output signal of the control coefficient generating unit 194 cross-fades with a predetermined time constant as in a signal 32. On the other hand, the output signal of the coefficient inverting unit 195 is an inversion signal 33 of the signal 32, and also cross-fades with a predetermined time constant. Accordingly, occurrence of overshoot and ringing can be prevented. Also, discontinuity of the waveform at switching of outputs of the attenuators 192 and 193 can be absorbed by audibility, which advantageously acts on the masking effect.

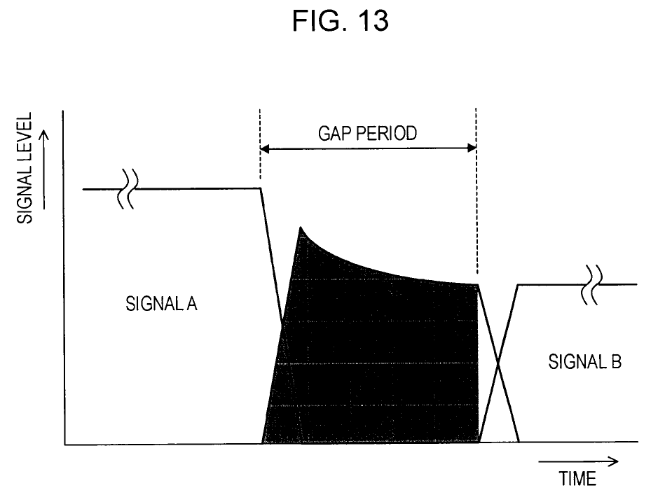

FIG. 13 illustrates an example of an interpolation signal in a case where the cross-fade switch 191 according to the embodiment of the present invention is used. Assuming that the interpolation signal illustrated in FIG. 8 is output from the level modulating unit 173, if the cross-fade switch 191 is used, cross-fade occurs in transition between signals A and B and the interpolation signal, so that smooth switching can be realized.

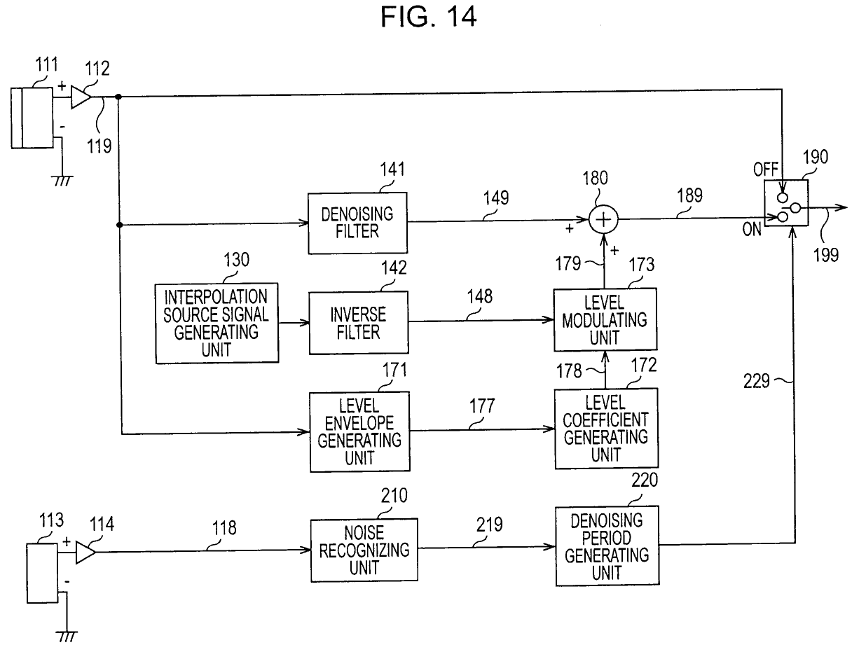

FIG. 14 illustrates a second configuration example of the noise reducing unit according to the embodiment of the present invention. This noise reducing unit receives a voice signal from the microphone 111, as in the first configuration example. In the second configuration example, a noise signal is input from a sensor 113. The sensor 113 is placed near a source of noise, and is realized by an acceleration sensor or a vibration sensor, for example. A negative-side terminal of the sensor 113 is grounded on a ground level of the circuit, and a positive-side terminal thereof connects to an amplifier 114. The amplifier 114 amplifies a noise signal. The amplified noise signal is supplied to the noise recognizing unit 210 of the noise reducing unit through a signal line 118.

In the second configuration example of the noise reducing unit, the noise recognizing unit 210 recognizes noise based on the noise signal from the sensor 113. Other than that, the second configuration example is basically the same as the first configuration example. Therefore, a denoising period is generated based on the noise signal from the sensor 113 and a noise reducing process is performed on the voice signal from the microphone 111.

In addition, the second configuration example is the same as the first configuration example in that the selecting switch 190 can be replaced by the cross-fade switch 191.

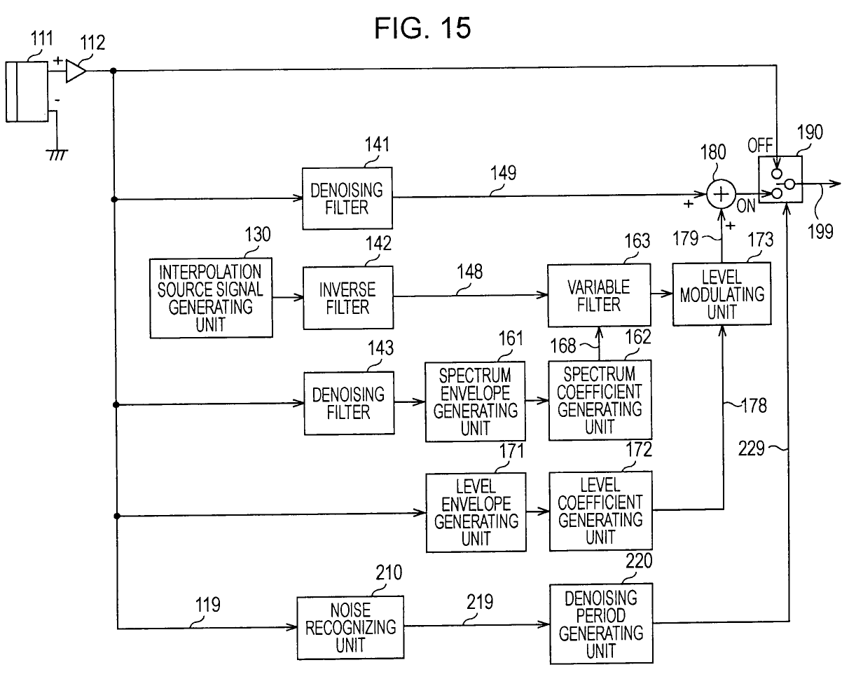

FIG. 15 illustrates a third configuration example of the noise reducing unit according to the embodiment of the present invention. This noise reducing unit receives a voice signal from the microphone 111, as in the first configuration example, and a noise reducing process is performed on the voice signal.

In the third configuration example, a denoising filter 143, a spectrum envelope generating unit 161, a spectrum coefficient generating unit 162, and a variable filter 163 are further provided in addition to the components in the first configuration example.

The denoising filter 143 eliminates a noise band from a voice signal from the microphone 111, as the denoising filter 141. An output of the denoising filter 143 is supplied to the spectrum envelope generating unit 161. The denoising filter 143 can be integrated into the denoising filter 141. In that case, an output of the denoising filter 141 is supplied to the spectrum envelope generating unit 161.

The spectrum envelope generating unit 161 continuously detects an envelope of a frequency spectrum (spectrum envelope) of the voice signal from the microphone 111. The spectrum envelope generating unit 161 detects a level of each frequency of the voice signal by FFT or band division, so as to detect a frequency spectrum. An output of the spectrum envelope generating unit 161 is supplied to the spectrum coefficient generating unit 162.

The spectrum coefficient generating unit 162 generates a spectrum coefficient based on the spectrum envelope supplied from the spectrum envelope generating unit 161. The spectrum coefficient generating unit 162 generates a spectrum coefficient to reproduce the frequency spectrum detected in the spectrum envelope generating unit 161. An output of the spectrum coefficient generating unit 162 is supplied to the variable filter 163 through a signal line 168.

The variable filter 163 performs frequency modulation on the interpolation source signal supplied from the inverse filter 142 in accordance with the spectrum coefficient supplied from the spectrum coefficient generating unit 162. Accordingly, continuous interpolation of frequency components is performed in addition to the level modulation by the level modulating unit 173, so that the gap length can be further increased based on the first characteristic.

The third configuration example is the same as the first configuration example in that the selecting switch 190 can be replaced by the cross-fade switch 191.

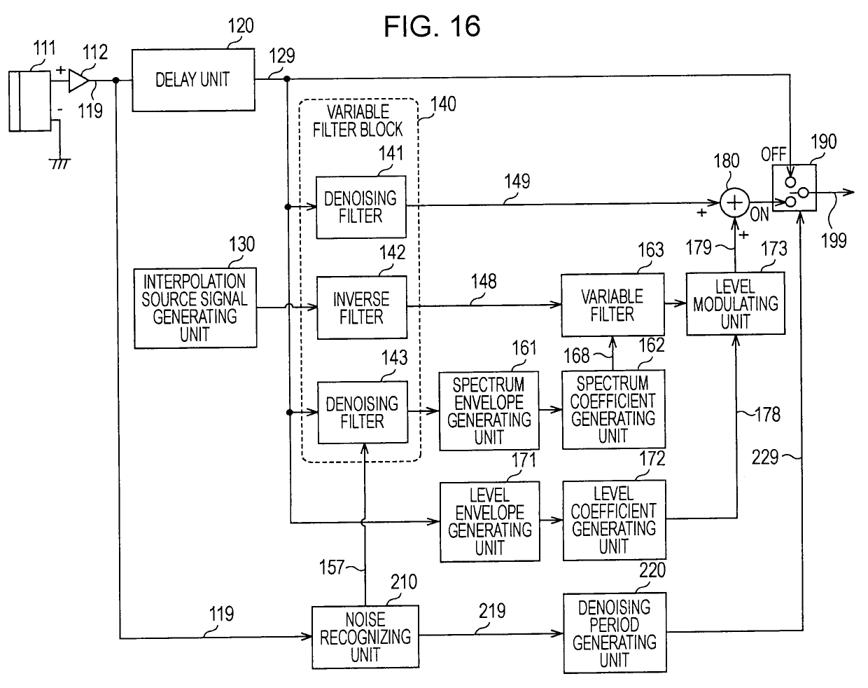

FIG. 16 illustrates a fourth configuration example of the noise reducing unit according to the embodiment of the present invention. As in the first to third configuration examples, this noise reducing unit receives a voice signal from the microphone 111 and performs a noise reducing process on the voice signal.

In the fourth configuration example, a delay unit 120 is provided in addition to the components in the third configuration example. An output of the delay unit 120, which is delayed by predetermined time, is supplied to the denoising filters 141 and 143 and the level envelope generating unit 171. Also, a signal line 157 from the noise recognizing unit 210 is supplied to the variable filter block 140. The variable filter block 140 includes the denoising filter 141, the inverse filter 142, and the denoising filter 143.

The noise recognizing unit 210 in the fourth configuration example detects the frequency of recognized noise and feeds it back to the variable filter block 140. A method for detecting a noise frequency is as follows. For example, when noise is recognized in the time region illustrated in FIG. 10A, the noise frequency can be calculated based on the scale parameter “a” corresponding to the highest matching with the noise pattern. On the other hand, when noise is recognized in the frequency region illustrated in FIG. 10B, the noise frequency can be calculated by detecting a noise peak frequency from the Fourier transform unit 215.

The noise frequency fed back from the noise recognizing unit 210 is used for adjusting a passband or a stopband in each filter of the variable filter block 140. Accordingly, for example, by adaptively changing the center frequencies fa, fb, and fc in FIGS. 5A and 5B in accordance with the noise frequency, variations in noise frequency and continuous noise from a plurality of noise sources can be effectively dealt with.

In the fourth configuration example, voice signal supply to each unit other than the noise recognizing unit 210 is performed via the delay unit 120, and thus the passband or the stopband can be adjusted in real time in accordance with a result of noise recognition.

The fourth configuration example is the same as the first configuration example in that the selecting switch 190 can be replaced by the cross-fade switch 191.

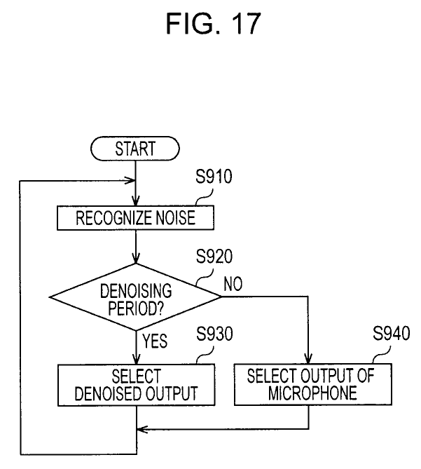

Now, an operation of the imaging apparatus according to the embodiment of the present invention is described with reference to FIG. 17.

FIG. 17 illustrates a basic processing procedure of a noise reducing method for a voice signal according to the embodiment of the present invention. This processing procedure is common to the above-described first to fourth configuration examples.

First, the noise recognizing unit 210 recognizes noise (step S910). Accordingly, the denoising period generating unit 220 generates a denoising period. In the denoising period (step S920), the selecting switch 190 selects the voice signal supplied from the denoising filter 141 through the signal line 149 (step S930). On the other hand, in the non denoising period (step S920), the selecting switch 190 selects the voice signal supplied from the microphone 111 through the signal line 119 (step S940). Then, the above-described process is repeated.

As described above, according to the embodiment of the present invention, a denoising period is specified in the noise recognized by the noise recognizing unit 210. The selecting switch 190 is controlled to select a signal from which noise has been removed by the denoising filter 141 during the denoising period, and to select a voice signal from which noise has not been removed during the other period. Accordingly, a noise reducing process in view of human's audibility can be realized. Also, according to the embodiment of the present invention, noise that continues over a long time can be reduced by combining an interpolation signal in the denoising period.

The above-described embodiment of the present invention is only an example to embody the present invention, and the respective elements described in the embodiment have a correspondence with a specific feature of the claims, as described below. However, the present invention is not limited to the embodiment, and various modifications can be carried out without deviating from the scope of the present invention.

In claim 1 at the time of the filing date of this application, the denoising means corresponds to the denoising filter 141, for example. The noise recognizing means corresponds to the noise recognizing unit 210, for example. The denoising period generating means corresponds to the denoising period generating unit 220, for example. The selecting means corresponds to the selecting switch 190, for example.

In claim 7 at the time of the filing date of this application, the denoising means corresponds to the denoising filter 141, for example. The signal interpolating means corresponds to a combination of at least part of the interpolation source signal generating unit 130, the inverse filter 142, the denoising filter 143, the spectrum envelope generating unit 161, the spectrum coefficient generating unit 162, the variable filter 163, the level envelope generating unit 171, the level coefficient generating unit 172, the level modulating unit 173, and the combining unit 180, for example. The noise recognizing means corresponds to the noise recognizing unit 210, for example. The denoising period generating means corresponds to the denoising period generating unit 220, for example. The selecting means corresponds to the selecting switch 190, for example.

In claim 8 at the time of the filing date of this application, the interpolation source signal generating means corresponds to the interpolation source signal generating unit 130, for example. The signal band attenuation means corresponds to the inverse filter 142, for example. The level envelope generating means corresponds to the level envelope generating unit 171, for example. The level coefficient generating means corresponds to the level coefficient generating unit 172, for example. The level modulating means corresponds to the level modulating unit 173, for example. The combining means corresponds to the combining unit 180, for example.

In claim 11 at the time of the filing date of this application, the interpolation source signal generating means corresponds to the interpolation source signal generating unit 130, for example. The signal band attenuation means corresponds to the inverse filter 142, for example. The spectrum envelope generating means corresponds to the spectrum envelope generating unit 161, for example. The spectrum coefficient generating means corresponds to the spectrum coefficient generating unit 162, for example. The spectrum modulating means corresponds to the variable filter 163, for example. The level envelope generating means corresponds to the level envelope generating unit 171, for example. The level coefficient generating means corresponds to the level coefficient generating unit 172, for example. The level modulating means corresponds to the level modulating unit 173, for example. The combining means corresponds to the combining unit 180, for example.

In claim 13 at the time of the filing date of this application, the voice signal obtaining means corresponds to the microphone 111, for example. The denoising means corresponds to the denoising filter 141, for example. The signal interpolating means corresponds to a combination of at least part of the interpolation source signal generating unit 130, the inverse filter 142, the denoising filter 143, the spectrum envelope generating unit 161, the spectrum coefficient generating unit 162, the variable filter 163, the level envelope generating unit 171, the level coefficient generating unit 172, the level modulating unit 173, and the combining unit 180, for example. The noise recognizing means corresponds to the noise recognizing unit 210, for example. The denoising period generating means corresponds to the denoising period generating unit 220, for example. The selecting means corresponds to the selecting switch 190, for example.

In claim 14 at the time of the filing date of this application, the first voice signal obtaining means corresponds to the microphone 111, for example. The denoising means corresponds to the denoising filter 141, for example. The signal interpolating means corresponds to a combination of at least part of the interpolation source signal generating unit 130, the inverse filter 142, the denoising filter 143, the spectrum envelope generating unit 161, the spectrum coefficient generating unit 162, the variable filter 163, the level envelope generating unit 171, the level coefficient generating unit 172, the level modulating unit 173, and the combining unit 180, for example. The second voice signal obtaining means corresponds to the sensor 113, for example. The noise recognizing means corresponds to the noise recognizing unit 210, for example. The denoising period generating means corresponds to the denoising period generating unit 220, for example. The selecting means corresponds to the selecting switch 190, for example.

In claim 15 at the time of the filing date of this application, the imaging means corresponds to the imaging unit 11, for example. The voice signal obtaining means corresponds to the microphone 111, for example. The denoising means corresponds to the denoising filter 141, for example. The signal interpolating means corresponds to a combination of at least part of the interpolation source signal generating unit 130, the inverse filter 142, the denoising filter 143, the spectrum envelope generating unit 161, the spectrum coefficient generating unit 162, the variable filter 163, the level envelope generating unit 171, the level coefficient generating unit 172, the level modulating unit 173, and the combining unit 180, for example. The noise recognizing means corresponds to the noise recognizing unit 210, for example. The denoising period generating means corresponds to the denoising period generating unit 220, for example. The selecting means corresponds to the selecting switch 190, for example. The recording means corresponds to the recording/reproducing unit 16, for example.

In claims 16 and 17 at the time of the filing date of this application, the imaging means corresponds to the imaging unit 11, for example. The voice signal obtaining means corresponds to the microphone 111, for example. The denoising means corresponds to the denoising filter 141, for example. The recognizing noise and the generating a signal indicating a denoising period corresponds to step S910, for example. The selecting corresponds to steps S920 to S940.

The processing procedure described in the embodiment of the present invention can be regarded as a method including a series of those steps, or as a program allowing a computer to execute the series of steps, or a recording medium storing the program.

What is claimed is:

1. A noise reducing circuit comprising:
denoising means for eliminating a noise band from an input voice signal;
noise recognizing means for recognizing noise included in the voice signal;
denoising period generating means for generating a signal indicating a denoising period in accordance with an occurrence period of the recognized noise; and
selecting means for selecting an output of the denoising means when the denoising period is indicated and selecting the voice signal when the denoising period is not indicated.

2. The noise reducing circuit according to claim 1,
wherein the noise recognizing means performs noise recognition by using an evaluation value, which is an output from a convolution operation of the voice signal and a wavelet signal whose waveform is similar to that of the noise and whose average value in a predetermined period is zero.

3. The noise reducing circuit according to claim 1,
wherein the noise recognizing means performs noise recognition by using an evaluation value, which is correlation between a pattern signal approximate to a frequency spectrum of the noise and the voice signal on which Fourier transform has been performed.

4. The noise reducing circuit according to claim 1,
wherein the denoising means is a filter to eliminate a noise band.

5. The noise reducing circuit according to claim 4,
wherein the denoising means adaptively changes an elimination band and a passband of the filter based on a frequency of the noise recognized by the noise recognizing means.

6. The noise reducing circuit according to claim 1,
wherein the selecting means is a cross-fade switch.

7. A noise reducing circuit comprising:
denoising means for eliminating a noise band from an input voice signal;
signal interpolating means for performing interpolation on the signal from which the noise band has been eliminated;
noise recognizing means for recognizing noise included in the voice signal;
denoising period generating means for generating a signal indicating a denoising period in accordance with an occurrence period of the recognized noise; and
selecting means for selecting an output of the signal interpolating means when the denoising period is indicated and selecting the voice signal when the denoising period is not indicated.

8. The noise reducing circuit according to claim 7,
wherein the signal interpolating means includes:
interpolation source signal generating means for generating an interpolation source signal for the interpolation;
signal band attenuation means for eliminating a band other than the noise band from the interpolation source signal;
level envelope generating means for generating a level envelope of the voice signal;
level coefficient generating means for generating a level coefficient for the interpolation based on the level envelope;
level modulating means for modulating an output of the signal band attenuation means based on the level coefficient; and
combining means for combining an output of the denoising means and an output of the level modulating means and outputting a resulting combination to the selecting means.

9. The noise reducing circuit according to claim 8,
wherein the level modulating means modulates the output of the signal band attenuation means further based on a level masked in audibility of the human.

10. The noise reducing circuit according to claim 8,
wherein the interpolation source signal generating means generates any of a single or a plurality of periodic signals having a predetermined waveform and a predetermined period, a white noise signal having a uniform level in a voice band, and a composite signal of the periodic signals and the white noise signal mixed with a predetermined mixing ratio.

11. The noise reducing circuit according to claim 7,
wherein the signal interpolating means includes:
interpolation source signal generating means for generating an interpolation source signal for the interpolation;
signal band attenuation means for eliminating a band other than the noise band from the interpolation source signal;
spectrum envelope generating means for generating a frequency spectrum envelope of an output of the denoising means;
spectrum coefficient generating means for generating a spectrum coefficient for the interpolation based on the spectrum envelope;
spectrum modulating means for modulating an output of the signal band attenuation means based on the spectrum coefficient;
level envelope generating means for generating a level envelope of the voice signal;
level coefficient generating means for generating a level coefficient for the interpolation based on the level envelope;
level modulating means for modulating an output of the spectrum modulating means based on the level coefficient; and
combining means for combining an output of the denoising means and an output of the level modulating means and outputting a resulting combination to the selecting means.

12. The noise reducing circuit according to claim 11,
wherein the denoising means and the signal band attenuation means are filters that adaptively change an elimination band and a passband based on a frequency of the noise recognized by the noise recognizing means.

13. A voice processing circuit comprising:
voice signal obtaining means for obtaining a voice signal;
denoising means for eliminating a noise band from the voice signal;
signal interpolating means for performing interpolation on the signal from which the noise band has been eliminated;
noise recognizing means for recognizing noise included in the voice signal;
denoising period generating means for generating a signal indicating a denoising period in accordance with an occurrence period of the recognized noise; and
selecting means for selecting an output of the signal interpolating means when the denoising period is indicated and selecting the voice signal when the denoising period is not indicated.

14. A voice processing circuit comprising:
first voice signal obtaining means for obtaining a first voice signal;
denoising means for eliminating a noise band from the first voice signal;
signal interpolating means for performing interpolation on the signal from which the noise band has been eliminated;
second voice signal obtaining means for obtaining a second voice signal;
noise recognizing means for recognizing noise included in the second voice signal;
denoising period generating means for generating a signal indicating a denoising period in accordance with an occurrence period of the recognized noise; and
selecting means for selecting an output of the signal interpolating means when the denoising period is indicated and selecting the first voice signal when the denoising period is not indicated.

15. An imaging apparatus comprising:
imaging means for capturing an image signal from a subject;
voice signal obtaining means for obtaining a voice signal from the subject;
denoising means for eliminating a noise band from the voice signal;
signal interpolating means for performing interpolation on the signal from which the noise band has been eliminated;
noise recognizing means for recognizing noise included in the voice signal;
denoising period generating means for generating a signal indicating a denoising period in accordance with an occurrence period of the recognized noise;
selecting means for selecting an output of the signal interpolating means when the denoising period is indicated and selecting the voice signal when the denoising period is not indicated; and
recording means for recording the image signal and the voice signal by multiplexing the image signal and the voice signal.

16. A noise reducing method for a voice signal in an imaging apparatus including imaging means for capturing an image signal from a subject, voice signal obtaining means for obtaining a voice signal from the subject, and denoising means for eliminating a noise band from the voice signal, the noise reducing method comprising the steps of:
recognizing noise included in the voice signal;
generating a signal indicating a denoising period in accordance with an occurrence period of the recognized noise; and
selecting an output of the denoising means when the denoising period is indicated and selecting the voice signal when the denoising period is not indicated.

17. A program allowing a computer to execute the steps of, in an imaging apparatus including imaging means for capturing an image signal from a subject, voice signal obtaining means for obtaining a voice signal from the subject, and denoising means for eliminating a noise band from the voice signal,
recognizing noise included in the voice signal;
generating a signal indicating a denoising period in accordance with an occurrence period of the recognized noise; and
selecting an output of the denoising means when the denoising period is indicated and selecting the voice signal when the denoising period is not indicated.

18. A noise reducing circuit comprising:
a denoising unit configured to eliminate a noise band from an input voice signal;
a noise recognizing unit configured to recognize noise included in the voice signal;
a denoising period generating unit configured to generate a signal indicating a denoising period in accordance with an occurrence period of the recognized noise; and
a selecting unit configured to select an output of the denoising unit when the denoising period is indicated and select the voice signal when the denoising period is not indicated.

19. A noise reducing circuit comprising:
a denoising unit configured to eliminate a noise band from an input voice signal;
a signal interpolating unit configured to perform interpolation on the signal from which the noise band has been eliminated;
a noise recognizing unit configured to recognize noise included in the voice signal;
a denoising period generating unit configured to generate a signal indicating a denoising period in accordance with an occurrence period of the recognized noise; and
a selecting unit configured to select an output of the signal interpolating unit when the denoising period is indicated and select the voice signal when the denoising period is not indicated.

20. A voice processing circuit comprising:
a voice signal obtaining unit configured to obtain a voice signal;
a denoising unit configured to eliminate a noise band from the voice signal;
a signal interpolating unit configured to perform interpolation on the signal from which the noise band has been eliminated;
a noise recognizing unit configured to recognize noise included in the voice signal;
a denoising period generating unit configured to generate a signal indicating a denoising period in accordance with an occurrence period of the recognized noise; and
a selecting unit configured to select an output of the signal interpolating unit when the denoising period is indicated and select the voice signal when the denoising period is not indicated.

21. A voice processing circuit comprising:
a first voice signal obtaining unit configured to obtain a first voice signal;
a denoising unit configured to eliminate a noise band from the first voice signal;
a signal interpolating unit configured to perform interpolation on the signal from which the noise band has been eliminated;
a second voice signal obtaining unit configured to obtain a second voice signal;
a noise recognizing unit configured to recognize noise included in the second voice signal;
a denoising period generating unit configured to generate a signal indicating a denoising period in accordance with an occurrence period of the recognized noise; and
a selecting unit configured to select an output of the signal interpolating unit when the denoising period is indicated and select the first voice signal when the denoising period is not indicated.

22. An imaging apparatus comprising:
an imaging unit configured to capture an image signal from a subject;
a voice signal obtaining unit configured to obtain a voice signal from the subject;
a denoising unit configured to eliminate a noise band from the voice signal;
a signal interpolating unit configured to perform interpolation on the signal from which the noise band has been eliminated;
a noise recognizing unit configured to recognize noise included in the voice signal;
a denoising period generating unit configured to generate a signal indicating a denoising period in accordance with an occurrence period of the recognized noise;
a selecting unit configured to select an output of the signal interpolating unit when the denoising period is indicated and select the voice signal when the denoising period is not indicated; and
a recording unit configured to record the image signal and the voice signal by multiplexing the image signal and the voice signal.
